(19) United States
(12) Patent Application Publication
(10) Pub. No.: US 2023/0304580 A1
(43) Pub. Date: Sep. 28, 2023

(54) PISTON RING

(71) Applicant: BÜMACH ENGINEERING INTERNATIONAL B. V., TA Emmen (NL)

(72) Inventor: Josef Bueter, Haren/Altenberge (DE)

(21) Appl. No.: 18/043,243

(22) PCT Filed: Sep. 11, 2020
(86) PCT No.: PCT/DE2020/000206

§ 371 Date: Feb. 27, 2023

(51) Int. Cl. F16J 9/16; F16J 9/20

(52) U.S. Cl. CPC F16J 9/16; F16J 9/20

(57) ABSTRACT

A piston ring has a ring body and a ring joint. The ring body has a first and a second ring body end which lie opposite each other and which define the ring joint. The first ring body end has a protruding section with a protrusion contour cross-section, and the second ring body end has a base section with a base section contour. A protruding section separating surface of the protruding section and a base section separating surface of the base section lie opposite each other so as to sealingly contact each other in a two-dimensional manner and define a separating plane. The separating plane has an inclination opposite that of a first axial ring surface. The separating plane defines an outer separating line and an inner separating line. At least one of the separating lines has a curvature radius which is concentric to the ring body.

The invention relates to a sealing piston ring with a particularly high sealing effect.

The state of the art describes a multitude of different piston rings. Piston rings are used in mechanical and automotive engineering, in particular for engines, hydraulic cylinders and many other areas of application. Basically, the function of piston rings is to seal the movement gap between the cylinder bore and the barrel surface of the piston against liquid and gaseous pressure media. For this purpose, particularly split piston rings are used in the state of the art. The splitting of the piston ring at the circumference is also known as the ring gap. Normally, piston rings have a resilient design to adapt to a cylinder bore. Piston rings are manufactured in a tension-free oval shape. They take on their intended rounded shape, which fits to the cylinder wall, when being installed, and then they exhibit a certain amount of pretension. Since the ring gap does not close completely in the installed condition to compensate for thermal elongations, there is always a certain amount of leakage. This results in pressure loss and medium overflow. As the sealing function of the piston ring depends on many factors, there is still a great need for optimization.

Firstly, the sealing surfaces are formed on the sliding surface, which is formed on the barrel surface of the cylinder bore and on a shoulder surface of the ring groove of the piston. Therefore, the surface pressure of the sealing function depends on the pressure of the medium and the pretension force of the sealing ring. The latter dependence is a constant magnitude so that only the pressure of the medium has a dynamic effect.

Further, it is basically known from the prior art to provide an overlap of the two opposing piston ring ends at the ring joint in order to reduce the open cross section and thus pressure loss and medium overflow. The disadvantages of this solution are that the sealing effect is too low for many applications and that the remaining leakage increases with increasing wear.

The task of the invention is to provide a sealing piston ring with a high sealing effect, which is suitable for a wide range of applications, in particular for hydraulic and pneumatic applications and for applications in combustion processes, such as internal combustion engines, and which has a high wear resistance.

The task is solved by the features indicated in claim 1. Preferred further embodiments result from the dependent claims.

The piston ring according to the invention is a substantially rotationally symmetric component which is split around the circumference and thus has a ring body and a ring joint.

The ring body has a ring body surface and a first and a second ring body end.

In particular, the ring body surface has a radial ring surface and an inclined ring surface. A second axial ring surface is provided opposite the first axial ring surface in a manner known per se.

The radial ring surface is formed as a sliding contact surface axially displaceable relative to a cylindrical inner barrel surface of a cylinder. Thus, the radial ring surface is in physical contact with the inner wall of the cylinder in a manner known per se when the piston according to the invention is used as intended, wherein the physical contact is a sliding contact when the piston moves with respect to the cylinder.

In addition, the ring body surface comprises the first axial ring surface which is formed as a lay-on surface to an axial ring groove surface of an outer ring groove of a piston.

The piston ring according to the invention engages in an outer ring groove of a piston in compliance with its intended purpose. The design of the first axial ring surface, which—when used as intended—is in sliding contact with a correspondingly designed lateral axial ring surface of a circumferential ring groove of a piston, enables the dynamic expansion of the piston ring. The operating pressure of a working medium acting radially outward on the piston ring on an inner radial ring surface leads to a radial expansion of the piston ring and to a force effect on the surface pressure between the radial ring surface and the inner barrel surface of the cylinder. This in turn provides an increased sealing effect. At the same time, the surface pressure is reduced to the surface pressure based on the spring effect during a return movement of the piston without working pressure and, thus, wear is reduced.

Furthermore, the inclined ring surface supports the automatic readjustment of the piston ring in case of wear of the radial ring surface or of the inner cylinder wall of the cylinder.

According to the invention, the ring body ends are arranged opposite to each other at the ring joint. Thus, they form the ring joint.

According to the invention, the first ring body end and the second ring body end are designed to complement each other. Specifically, the first ring body end comprises a projection section and the second ring body end comprises a base section.

The first ring body end has the projection section with a projection contour cross section. The projection contour cross section is defined by the shape of the projection and denotes the contour of the projection section in a radial sectional plane parallel to the main longitudinal axis. Thus, the projection contour is formed by a physical section of the piston ring.

The second ring body end has a base section with a base section contour, wherein the base section simultaneously forms a receiving contour with a receiving contour cross section. The base section contour is formed by a physical section of the piston ring, whereas the receiving contour is a free space. The receiving contour cross section is defined by the free space not filled by the base section contour and is also a contour in the radial section plane parallel to the main longitudinal axis. The section plane is the same as the one of the projection section contour cross section.

According to the invention, the projection section engages in the receiving contour. Here, the receiving contour cross section and the projection contour cross section coincide. The projection contour cross section as a physical category fills the receiving contour cross section as a free space.

According to the invention, a projection section separating surface of the projection section and a base section separating surface of the base section are provided opposite to each other in areal and sealing physical contact and form a separating plane. The projection section separating surface and the base section separating surface are hereinafter collectively also referred to as the separating surfaces.

The separating surface has an inclination with respect to the first axial ring surface. An inclination is to be understood such that the separating surface has an inclination with respect to the first axial ring surface and thus simultaneously to a main areal plane of the piston ring.

According to the invention, the separating plane is further characterized by the fact that it intersects the radial ring surface and forms an outer separating line at an intersection line of the separating plane with the radial ring surface.

In addition, the separating line also intersects the first axial ring surface and forms an inner separating line at an intersection line of the separating plane with the first axial ring surface.

Hereinafter, the outer separating line and the inner separating line are also collectively referred to as the separating lines.

The two separating lines also define the two separating surfaces. They are the radial boundaries of the two separating surfaces.

In particular, the piston ring according to the invention is characterized in that at least one of the two separating lines has a curvature radius which is concentric with respect to the ring body.

Thus, a solution has been surprisingly found which reliably provides almost complete sealing against fluid and gaseous pressure media, as the ring body ends always automatically align axially, radially and also tangentially relative to each other by the inclination of the separating plane and by the concentric separating line design so that a sealing areal physical contact is formed at the separating surfaces.

The ring body ends engaging one into the other and designed in this way have a very precise sealing geometry that exhibits a sealing overlap even with variable circumferential expansion and the resulting variable ring gap. This feature also results from the fact that at least one separating line, preferably both separating lines, has/have a concentric curvature radius. Thus, the piston ring can expand or contract in the circumferential direction at any time and the seal via the separating line is maintained. The expansion or contraction around the circumference can result from an undulating shape of the inner barrel surface of the cylinder or from temperature-induced expansion or shrinkage or from wear.

Advantageously, the piston ring according to the invention is capable to compensate for these factors while simultaneously maintaining its particularly high tightness.

In addition, the projection section can slide radially and in circumferential direction on the separating surface to the base section at any time. This ensures wear compensation at all times, resulting in a consistent sealing function.

It is also advantageous that a solution has been found in which the sealing piston ring comprises two axial ring surfaces in the outer contour which are parallel to one another and lie in its main areal plane so that an outer ring groove can be formed in a structurally simple manner in a piston for receiving the piston ring according to the invention.

A particular advantage of the sealing piston ring according to the invention is that the substantially rectangular geometry of its outer cross section corresponds to the geometry of the cross section of the piston rings to be found in most applications. This allows in a particularly advantageous manner to use the piston ring according to the invention in devices such as, in particular, internal combustion engines, working cylinders or damping cylinders, without them requiring any design modification. In suitable cases, even existing devices can be optimized by replacing existing piston rings with the high-density piston ring according to the invention.

Furthermore, it is advantageous that the piston ring can be preferably made of metal and, thus, it can also withstand high temperature stresses.

Advantageously, the piston ring according to the invention can thus be used, particularly, in combustion engines, but also in hydraulic or pneumatic working cylinders or damping cylinders as well as in all other applications in which a high degree of tightness is required or is particularly advantageous.

According to a first advantageous further development, both the outer separating line and the inner separating line have a radius of curvature that is concentric with respect to the ring body. In addition, both separating lines thus have a curvature radius that is concentric with respect to each other and thus the same.

This development has the particularly advantageous effect that both at the radial ring surface, which is in sealing sliding contact to the inner barrel surface of the cylinder, and at the inclined ring surface, which is in sealing contact with the lateral surface of the ring groove of the piston, all the sealing surfaces involved come together and thus provide a particularly high level of sealing.

Furthermore, it is advantageously made possible that a change in the circumference of the piston ring does not have any effect on the sealing, since the separating surface of the projection section and the separating surface of the base section can move tangentially one to the other, i.e., along the curvature radius, and thus maintain the areal sealing physical contact.

According to a next advantageous further development, the separating surfaces of the ring body ends are designed as lateral truncated-cone surfaces.

In this development, the separating surface of the projection section, which is designed as a truncated-cone surface, and the separating surface of the base section, which is designed as a truncated-cone surface, are opposite to each other, wherein the separating surface of the projection section is a concave inner truncated-cone surface and the separating surface of the base section is a convex outer truncated-cone surface. The two opposing truncated-cone surfaces have the same geometry and can therefore be moved both longitudinally and transversely relative to each other, thus ensuring a particularly high level of tightness.

Due to this shape of the separating surfaces, the sealing effect is maintained even in the event of changes in the circumference or in case of wear. Furthermore, the inclination relative to the axial ring groove surface of the outer ring groove reinforces the sealing surface pressure thanks to the radial force effect.

According to a next advantageous further development, the receiving contour cross section is designed as a triangle.

It forms the shape of a right-angled triangle. Here, one cathetus corresponds to the radial ring surface, the second cathetus to the first axial ring surface and the hypotenuse to the projection section separating surface.

The triangular contour of the receiving contour cross section allows a, particularly from wear resulting, compensation of the positional relationships between the base section, the projection section and the inner barrel surface of the cylinder, while maintaining the areal sealing physical contact and consequently the sealing effect. Thus, the above-mentioned components align themselves automatically relative to each other and, therefore, they bring about the wear-independent tightness.

In a next advantageous further development, the separating surfaces are designed as wire erosion surfaces. This precise manufacturing process leads to surfaces with a high overlap accuracy of the projection section separating surface and the base separating surface. Leakage through gaps between the separating surfaces, which can be caused by other manufacturing processes, is thus advantageously minimized or even completely eliminated. The result is a reliable sealing effect.

According to a further advantageous further development, the piston ring is provided with at least one weakening recess. Preferably, there are several weakening recesses which are distributed around the circumference at a uniform angular distance from each other and from the ring joint. This design uniformly reduces the spring-force-induced contact forces on an inner barrel surface of a cylinder distributed around the circumference and supports the free movement and self-adjusting action between the projection section and the base section. And, at the same time, the advantageous contact forces caused by the operating pressure of a pressure medium remain unimpaired. It is particularly advantageous that a piston ring with the same initial geometry and the same material can thus be adapted by the spring-force-induced contact pressure to the individual application requirements in a simple manner.

A further aspect of the invention is a piston ring arrangement. This arrangement has a first and a second piston ring, wherein these two piston rings are piston rings according to the invention.

According to the invention, the piston rings each have a second axial ring surface. In addition, the piston rings are arranged in parallel, wherein the second axial ring surface of the first piston ring and the second axial ring surface of the second piston ring rest in physical contact one at the other. Thus, the two piston rings are arranged either rotated or mirrored to each other in the same ring groove of the piston. The ring groove has a rectangular cross section and has two parallel axial groove side surfaces for this purpose. In their main areal plane, the piston rings are slidably movable relative to each other and relative to the piston in the ring groove and are thus supported in a floating manner.

This arrangement according to the invention represents a further solution with particular advantages for a double-acting cylinder. Two mutually mirrored piston rings are used one on top of the other. This makes it possible to provide an equally effective seal against a pressure medium that alternately acts from two axially opposite sides. This variant also has the advantage that compensation for different tolerances of the cylinder-piston arrangement is significantly improved by the installation position of the rings floating relative to each other. There is also the technological advantage and cost benefit that the first and the second piston ring are preferably identical and thus only one type of piston ring can be used in two exemplars.

By using an exemplary embodiment, the invention is explained in more detail below on the basis of the attached drawings. They show:

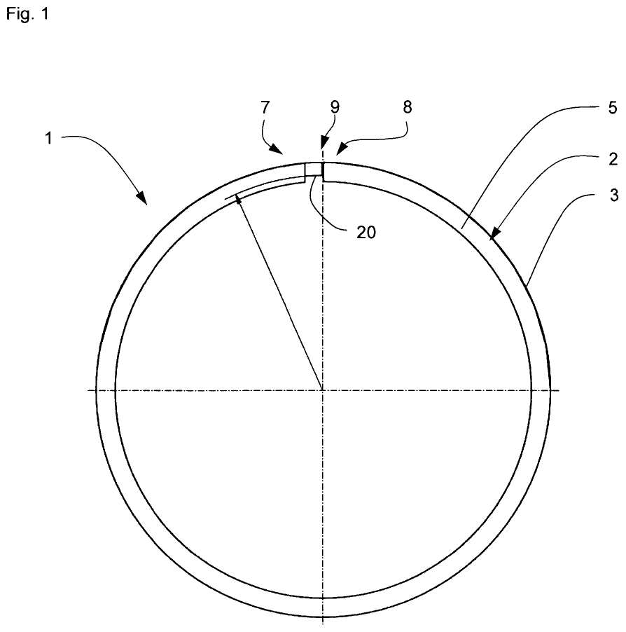

FIG. 1 Top view of a piston ring

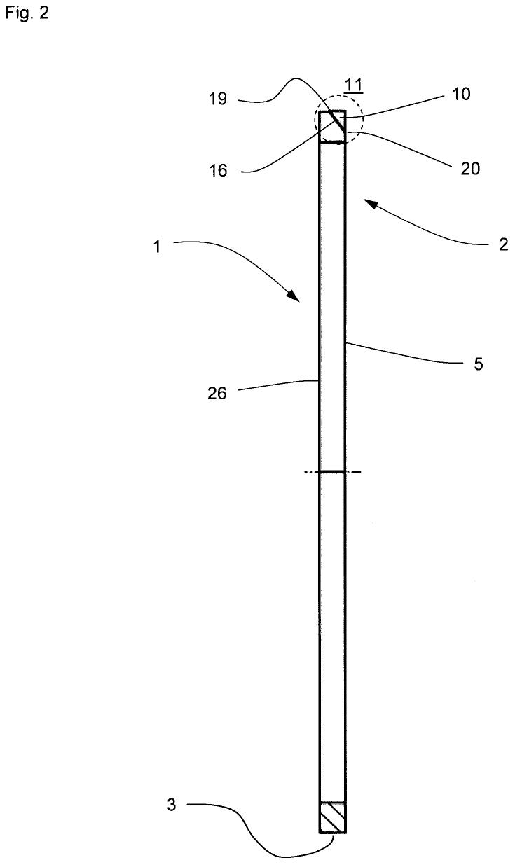

FIG. 2 Cross sectional view of a piston ring

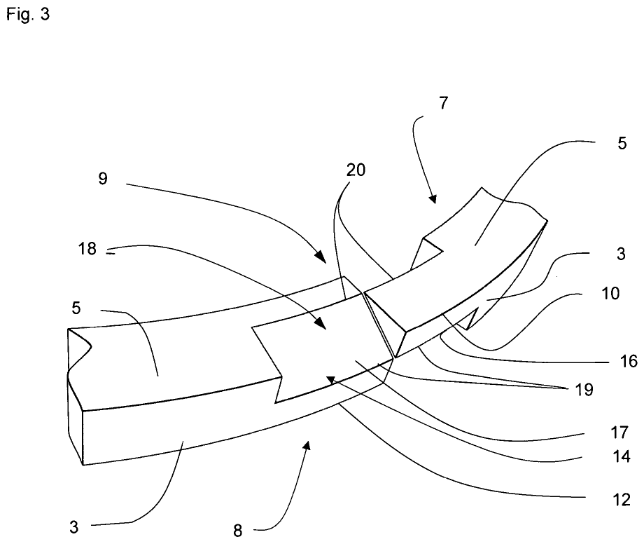

FIG. 3 Detailed section of a piston ring at the ring body ends in an oblique view

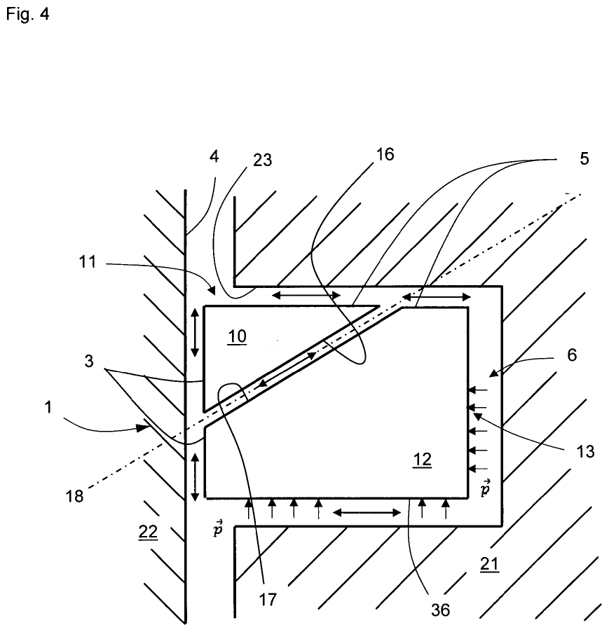

FIG. 4 Sectional view and schematic representation of the ring body ends

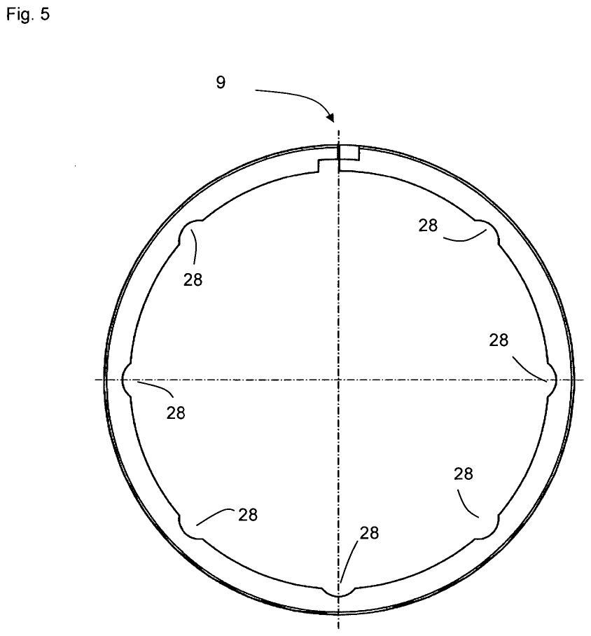

FIG. 5 Top view of a piston ring with weakening recesses

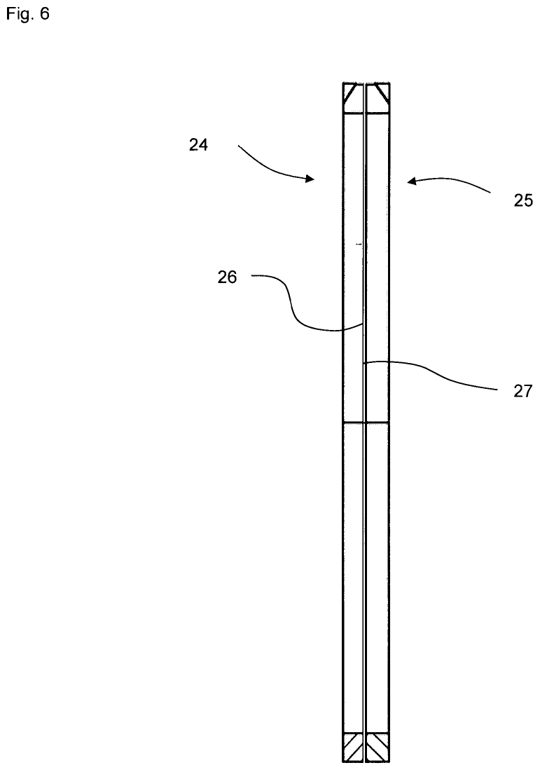

FIG. 6 Cross sectional view of a piston ring arrangement.

FIG. 1 shows the piston ring in a top view along the main longitudinal axis, which corresponds to the movement axis of the piston. The figure depicts the ring body 1 with the ring body surface 2, which comprises the radial ring surface 3 and the first axial ring surface 5. The ring body 1 is interrupted at one point. Here, a first ring body end 7 and a second ring body end 8 are opposite each other. The interruption between them is the ring joint 9.

The ring is shown in the unassembled, relaxed production position, also referred to as the relaxation position. In this embodiment, the ring body ends 7, 8 do not project one above the other in the relaxation position. In an alternative design—not shown here—a partial projection into the respective other ring body end 7, 8 already exists in the relaxation position.

In FIG. 1, an arc is also drawn over the inner separating line 20 with a radius arrow to show the concentric formation of the inner separating line 20, which is essential for the invention.

FIG. 2 shows the cross section of the ring body 1 through the ring joint 9. The ring body surface 2 designates the surface of the complete piston ring. The outer barrel surface of the ring body 1 is the radial ring surface 3. On one of the two sides of the ring body 1 is the first axial ring surface 5. The second axial ring surface 26 is provided opposite to it. By means of this surface the piston ring engages in the matching counter contour of a circumferential ring groove of a piston. Furthermore, the figure shows the projection section 10 with the projection contour cross section 11—highlighted by the dashed circular line—as well as the projection section separating surface 16. The inner separating line 20 is located on the first axial ring surface 5 and the outer separating line 19 is located on the radial ring surface 3, and both are concentric to each other and to the ring body 1 as a whole.

FIG. 3 shows the section of the piston ring at the ring joint 9 and at the ring body ends 7, 8 in an oblique view.

In this view, the non-installed shape of the piston ring is illustrated in the relaxation position. It shows the outside of the piston ring in the direction of the radial ring surface 3. The first axial ring surface 5 is located circumferentially at an angle of inclination to this. The projection section 10 is located at the first ring body end 7 and comprises the projection section separating surface 16 opposite to the view direction of FIG. 3.

The corresponding counterpart at the second ring body end 8 is the base section 12. The receiving contour 14 is defined by the separating plane 18; it forms the base section separating surface and receives the projection section 10 in an areal manner. In the tensioned installation position, the projection section 10 with the projection section separating surface 16 lies flat on the base section 12, i.e., on the base section separating surface 17. The separating plane 18 is formed there. The piston ring interrupted at the ring joint 9 is sealed again by the areal contact of the projection section separating surface 16 and the base section separating surface 17 in the separating plane 18.

In the overlap zone of the projection section separating surface 16 and the base section separating surface 17, the separating plane 18 has the shape of a section of a truncated-cone surface in this exemplary embodiment. The inner separating line 20 is formed at the curved edge to the first axial ring surface 5 and the outer separating line 19 is formed at the curved edge to the radial ring surface 3. The separating lines 19, 20 describe circular arcs which are arranged concentrically to the circle center point of the ring body, which enables a congruent sliding of the projection section separating surface 16 and the base section separating surface 17 on top of each other during a circumferential expansion or circumferential reduction of the piston ring.

FIG. 4 is a schematic representation of the piston ring in the installed condition. The individual gaps between the various components are greatly enlarged for a better view and are not true to scale. FIG. 4 as a schematic diagram is intended to illustrate the positional and movement relationships of the components as well as the acting forces.

Thus, according to FIG. 4, the ring body 1 is installed in a ring groove 6 of a piston 21. The ring groove 6 comprises an axial ring groove surface 23. When the piston moves in the cylinder, the piston ring slides axially off the inner barrel surface 4 of the cylinder 22 with its radial ring surface 3. The pressure medium acts with the pressure p on the second axial ring surface of the piston ring. The piston ring is pressed in the ring groove 6 of the piston 21 against the axial ring groove surface 23 and slides in a floating manner thereon with its first axial ring surface 5. At the same time, the pressure medium acts in the area of the groove base of the ring groove 6 against the radial inner ring surface of the piston ring (no reference numeral) and, depending on the pressure, ensures that the radial ring surface 3 is pressed against the inner barrel surface 4 of the cylinder 22, which leads to an increased sealing effect at this sliding contact surface. In addition, the projection contour cross section 11 can slide off with the projection section separating surface 16 on the base section separating surface 17 of the base section contour 13 along the separating plane 18 both transversely—as shown by the double arrow between the separating surfaces 16, 17— and longitudinally, i.e., along the circumference. At the same time, the projection section 10 and the base section 12 are axially displaceable with respect to each other along the radial ring surface 3 and the inner barrel surface 4 so that the gap between the separating surfaces 16, 17 can always be closed again, even in the case of wear.

This sliding-off of the separating surfaces 16, 17 transversely and longitudinally in conjunction with the axial displaceability of the sections 10, 12 enables compensation for material abrasion on the piston ring due to wear and always ensures areal contact and thus a constant sealing effect during the service life.

FIG. 5 depicts a piston ring in which weakening recesses 28 are arranged opposite the radial ring surface 3. A total of seven weakening recesses 28, which are arranged at an angle of 45 degrees to each other, are provided in the exemplary embodiment. Furthermore, the weakening recesses 28 adjacent to the ring joint 9 each include an angle of likewise 45 degrees with respect to the ring joint 9. Due to the weakening recesses 28 and due to their uniform distribution, the spring-force-induced contact forces against an inner barrel surface 4 of a cylinder are reduced around the circumference in a uniformly-distributed manner, and the free movability and self-adjusting action between the projection section and the base section are supported. And, at the same time, the advantageous contact forces caused by the operating pressure of a pressure medium remain unimpaired.

FIG. 6 shows a piston ring arrangement comprising a first piston ring 24 and a second piston ring 25. Both piston rings 24, 25 are designed as piston rings according to the invention. In addition, they each have a second axial ring surface 26, 27. The two piston rings 24, 25 lie against each other at the axial ring surfaces 26, 27, wherein in this manner they are mounted in floating position relative to each other.

### REFERENCE NUMERALS

1 ring body
2 ring body surface
3 radial ring surface
5 inner barrel surface
5 first axial ring surface
6 outer ring groove of a piston
7 first ring body end
8 second ring body end
9 ring joint
10 projection section
11 projection contour cross section
12 base section
13 base section contour
14 receiving contour
15 receiving contour cross section
16 projection section separating surface
17 base section separating surface
18 separating plane
19 outer separating line
20 inner separating line
21 piston
22 cylinder
23 axial ring groove surface
24 first piston ring
25 second piston ring
26 second axial ring surface of the first piston ring
27 second axial ring surface of the second piston ring
28 weakening recess

1-7. (canceled)

8. A piston ring for a piston with an outer ring groove having an axial ring groove surface, the piston for disposition in a cylinder with a cylindrical inner barrel surface, the piston ring comprising:
a ring body having a first ring body end and a second ring body end and a ring joint, said first and second ring body ends being arranged opposite one another for defining said ring joint;
said ring body having a ring body surface including a radial ring surface being a sliding contact surface axially displaceable relative to the inner barrel surface and a first axial ring surface being a lay-on surface for resting on the axial ring groove surface;
said first ring body end having a projection section with a projection section separating surface and a projection contour cross section;
said second ring body end having a base section with a base section separating surface and a base section contour, said base section defining a receiving contour with a receiving contour cross section, said projection section engaging in said receiving contour, and said receiving contour cross section and said projection section cross section coincide;
said projection section separating surface and said base section separating surface being provided opposite one other in an areal and sealing physical contact and defining a separating plane;
said separating plane having an inverse inclination with respect to said inclined ring surface, said separating plane intersecting said radial ring surface and defining an outer separating line at an intersection line of said separating plane with said radial ring surface, said separating plane intersecting said first axial ring surface and defining an inner separating line at a second intersection line of said separating plane with said first axial ring surface, said separating lines defining said separating surfaces, and at least one of said separating lines having a curvature radius concentric with said ring body.

9. The piston ring according to claim 8, wherein said outer separating line and said inner separating line have a curvature radius concentric with said ring body and with one other.

10. The piston ring according to claim 8, wherein said separating surfaces are constructed as lateral truncated-cone sub-surfaces.

11. The piston ring according to claim 8, wherein said receiving contour cross section is a triangle.

12. The piston ring according to claim 8, wherein said separating surfaces are constructed as wire erosion surfaces.

13. The piston ring according to claim 8, wherein said ring body has at least one weakening recess arranged radially on the inside.

14. A piston ring arrangement, comprising:
a first piston ring and a second piston ring, said piston rings are constructed according to claim 8;
said piston rings each having a respective second axial ring surface, and said piston rings being arranged in parallel, said second axial ring surface of said first piston ring and said second axial ring surface of said second piston ring resting in physical contact against each other.
